(19) United States
(12) Patent Application Publication
(10) Pub. No.: US 2024/0207816 A1
(43) Pub. Date: Jun. 27, 2024

(54) METHOD OF MANUFACTURING A HUMIDITY CONTROL DEVICE AND HUMIDITY CONTROL DEVICE

(71) Applicant: AIRNOV, INC., Wilmington, New Castle, DE (US)

(72) Inventors: Sebastien Ohl, Malakoff (FR); Valere Logel, Levallois Perret (FR)

(21) Appl. No.: 18/555,365

(22) PCT Filed: Apr. 14, 2022
(86) PCT No.: PCT/EP2022/060126

§ 371 Date: Oct. 13, 2023

(30) Foreign Application Priority Data
Apr. 14, 2021 (EP) 21168342.0

(51) Int. Cl. B01J 20/28; B01D 53/26; B01D 53/28; B01J 20/10; B01J 20/12; B01J 20/24; B01J 20/26; B65D 81/26

(52) U.S. Cl. CPC B01J 20/2805; B01D 53/261; B01D 53/28; B01J 20/103; B01J 20/12; B01J 20/24; B01J 20/267; B65D 81/268; B01D 2253/11; B01D 2253/202; B01D 2257/80; B01D 2259/4525

(57) ABSTRACT

A method of manufacturing a humidity control device including the steps of: a) providing an envelope in an open configuration; b) introducing in at least one part of the open envelope a given weight of a humidity control agent having a known moisture content lower than the moisture content corresponding to a targeted equilibrium relative humidity level (ERHi); c) introducing a given weight of water in the at least one part of the open envelope; and d) repeating steps b) and c) until a desired weight of hydrated humidity control agent is received in the at least one part of the open envelope.

### FIELD OF THE INVENTION

The present invention relates to a method of manufacturing a humidity control device for controlling humidity within a desired range in an enclosure, in particular in a container such as a medicinal, nutraceutical or pharmaceutical container. The invention also relates to a humidity control device.

### BACKGROUND OF THE INVENTION

Some products can lose freshness, or become damaged or even unusable, when they are subjected to environments with too much or too little humidity. For example, medicinal cannabis products, e.g. in the form of loose cannabis or pre-rolled cannabis products, can benefit from an environment with a controlled humidity. An adjusted humidity level makes it possible to preserve the fidelity of the volatile medicinal compounds of cannabis, such as cannabinoids, terpenes and flavonoids, so that the therapeutic effect of medicinal cannabis is intact, and the dose is delivered to a patient in an efficient way. In a similar way, nutraceutical or pharmaceutical products, e.g. in the form of herbs, gelatin capsules or gummies, may be better preserved in a controlled humidity environment.

To reach a desired humidity level for products, it is known to provide desiccants within a package or container in which the products are stored. However, desiccants alone do not control humidity within a desired range. To maintain humidity within a given range in an enclosure, it is known to use polymeric film pouches filled with a saturated aqueous salt solution. Such pouches are configured to provide a two-way humidity control, i.e. to both absorb and release moisture. A liquid-tight envelope is required to contain such a saturated aqueous salt solution, which is not the case of the envelope materials conventionally used for capsules or packets filled with desiccants. In addition, the relative humidity range that can be reached with a saturated aqueous salt solution is determined by the chemical nature of the salt. Then, a change in the targeted humidity range requires a change in the salt used for the saturated aqueous salt solution. It follows that several raw material supplies are needed to meet different markets, resulting in increased costs and more complex validation processes, especially for the nutraceutical and pharmaceutical sectors having specific requirements.

It is these drawbacks that the invention is intended more particularly to remedy by proposing a method of manufacturing a two-way humidity control device with optimal management of costs and quality risks, which can be based on conventional envelope materials used for desiccant capsules or packets, and which can be easily adapted to reach different targeted humidity levels within a broad relative humidity range.

### DISCLOSURE OF THE INVENTION

For this purpose, a subject of the invention is a method of manufacturing a humidity control device for maintaining the relative humidity in an enclosure within a given range by absorbing or releasing water vapor, said humidity control device comprising a water vapor permeable envelope and a hydrated humidity control agent arranged inside the envelope, wherein the hydrated humidity control agent has an adjusted moisture content so selected as to provide a targeted equilibrium relative humidity level (ERHi) in a sealed container, said method comprising steps of:
a) providing the envelope in an open configuration;
b) introducing, in at least one part of the open envelope, a given weight of the humidity control agent having a known moisture content strictly lower than the moisture content corresponding to the targeted equilibrium relative humidity level (ERHi);
c) introducing a given weight of water in the at least one part of the open envelope;
d) optionally, repeating steps b) and c) until a desired weight of hydrated humidity control agent, having the moisture content corresponding to the targeted equilibrium relative humidity level (ERHi) of the humidity control device, is received in the at least one part of the open envelope.

In the above method, steps b) and c) may be performed in any sequence order, or in parallel.

According to one feature of the method, the adjusted moisture content of the hydrated humidity control agent corresponds to a targeted equilibrium relative humidity level (ERHi) situated in the range of 10% RH to 100% RH, optionally 15% RH to 95% RH, optionally 25% RH to 90% RH, optionally 35% RH to 90% RH, optionally 45% RH to 90% RH, optionally 50% RH to 80% RH.

In the context of the invention, the targeted equilibrium relative humidity level (ERHi) of a humidity control device is defined as the equilibrium value of the relative humidity which is reached in an empty and moisture-tightly closed glass vessel comprising therein at least one of said humidity control device so that a weight of hydrated humidity control agent per volume of air in the closed glass vessel is higher than or equal to 65 g/L. In order to determine the equilibrium value, the evolution of the relative humidity inside the glass vessel over time is measured, e.g. by means of a humidity probe such as the HC2A-S humidity probe sold by the company Rotronic, until an equilibrium value is reached. The equilibrium value of the relative humidity is obtained when a variation of the relative humidity inside the glass vessel is less than ±1% RH over 6 consecutive hours. Within the frame of the invention, the targeted equilibrium relative humidity level (ERHi) of a humidity control device is determined at ambient temperature, typically 20° C.±2° C.

Within the meaning of the invention, the moisture content (also abbreviated as “MC”) of a humidity control agent relates to the amount of water (usually expressed as weight) absorbed in the humidity control agent relative to the dry weight of said humidity control agent. Herein, the moisture content is usually expressed in percent by weight.

Within the meaning of the invention, the terms “absorb”, “absorbing” or “absorption”, when referring to a given material, with respect to water, are used to encompass all chemical and physical phenomena by which water may be retained by said material. In particular, this includes bulk phenomena, generally referred to as “absorption”, where water molecules enter the material; or surface phenomena, generally referred to as “adsorption”, where water molecules attach to the surface of the material.

In the context of the invention, a moisture-tightly closed glass vessel has a Water Vapor Transmission Rate (WVTR) of less than 1 mg per 24 hours and per gram of hydrated humidity control agent present in the closed glass vessel, measured in an environment at 40° C. with a relative humidity of 75% RH.

Advantageously, the hydrated humidity control agent of a humidity control device according to the invention can absorb moisture from the surrounding atmosphere, when the relative humidity is higher than the targeted equilibrium relative humidity level (ERHi), and release moisture to the surrounding atmosphere, when the relative humidity is lower than the targeted equilibrium relative humidity level (ERHi). Thus, the humidity control device is a two-way humidity control device.

Examples of humidity control agents that may be used when implementing the method of the invention include, without limitation: a superabsorbent polymer; a silica gel; a clay, e.g. a bentonite; or any combination thereof. These materials can be hydrated to a hydration level corresponding to the targeted equilibrium relative humidity level (ERHi).

The method of the invention, in which a hydrated humidity control agent is prepared in situ in the envelope of the humidity control device, has several advantages. First, compared to existing methods where a quantity of hydrated humidity control agent is prepared beforehand, as an intermediate product having said adjusted moisture content corresponding to the targeted equilibrium relative humidity level (ERHi), and is dispensed successively in several envelopes of humidity control devices, the above method eliminates a preliminary process step and avoids having to store and dispense the intermediate product. The above method also eliminates the need to define suitable packaging and storage conditions to avoid any drift in the moisture content of the intermediate product and therefore in the corresponding targeted equilibrium relative humidity level (ERHi). This results in reduced quality risks and in reduced costs.

Another advantage of the method of the invention is that the quantity of water to be added into the envelope of the humidity control device can be adjusted precisely according to the initial moisture content of the humidity control agent introduced in the envelope. In particular, the initial moisture content of the humidity control agent to be introduced in successive envelopes can be measured for each new batch of humidity control agent used on a manufacturing line, or even continuously, whereas the quantity of water to be added in one envelope is adjusted, e.g. automatically, according to the initial moisture content measured for the humidity control agent introduced in said envelope.

Due to the relatively small volume of the envelope of the humidity control device, the method of the invention, in which the hydrated humidity control agent is prepared in situ in the envelope, also eliminates the need for a mixing or homogenization operation to obtain the hydrated humidity control agent. Because of the relatively low amounts of water and humidity control agent introduced in each envelope, the water tends to be well distributed relative to the humidity control agent, even in the absence of mixing. Advantageously, the absence of a mixing operation makes it possible to avoid generating dust by mechanical abrasion of the particles of the humidity control agent, while also limiting the changes in particle size of the humidity control agent.

In practice, changes in the particle size of the humidity control agent may occur due to a mixing operation, or else due to the presence of water when the humidity control agent is pre-hydrated. For example, adding water to a silica gel can cause the particles to burst due to the exothermic water adsorption reaction, whereas adding water to a superabsorbent polymer can cause the formation of lumps, thus inducing changes in particle size. Such changes in particle size may impact the bulk density of the humidity control agent, thus making it difficult to accurately dose a given weight of the humidity control agent to be introduced in the envelope, in particular when a volumetric metering device is used.

According to one feature of the method, the method further comprises a step e) of closing the envelope once a desired weight of hydrated humidity control agent, having the moisture content corresponding to the targeted equilibrium relative humidity level (ERHi), is received in the at least one part of the open envelope, so that the hydrated humidity control agent is retained inside the envelope.

According to one feature of the method, the hydrated humidity control agent is in a powder form, a granulate form and/or a solid agglomerated form. Preferably, the humidity control agent is in a powder form, a granulate form and/or a solid agglomerated form in its initial state, where its moisture content is strictly lower than the moisture content corresponding to the targeted equilibrium relative humidity level (ERHi), and in its final hydrated state, where its moisture content corresponds to the targeted equilibrium relative humidity level (ERHi).

According to one feature of the method, the humidity control agent is introduced in the at least one part of the open envelope in a substantially dry state. The use of a substantially dry humidity control agent when filling the envelope facilitates dosing and improves dosing accuracy, especially when the dose of humidity control agent to be introduced in the envelope is prepared using a volumetric metering device, as this ensures good control of the particle size and therefore the bulk density of the humidity control agent.

According to one feature of the method, the water is introduced in the at least one part of the envelope in a liquid state, which makes it possible to easily and precisely control the amount of water added to the humidity control agent, and thus the moisture content of the final hydrated humidity control agent.

According to one feature of the method, the given weights of water and of humidity control agent are introduced in the at least one part of the envelope at a rate such that the time required for the water to be absorbed by the humidity control agent is lower than the time required for the water to leak out of the at least one part of the envelope.

According to one embodiment of the method, the at least one part of the open envelope for receiving the humidity control agent and the water is formed by a gas-permeable membrane, and a given weight of the humidity control agent is introduced in the at least one part of the open envelope formed by the gas-permeable membrane before a given weight of water in a liquid state is also introduced therein. This may be implemented, e.g., for the manufacturing of humidity control bags or packets, where the open envelope comprises a partially welded tube of porous material. In this case, the humidity control agent in a substantially dry state may advantageously be introduced first in the open envelope, and the liquid water may then be added thereto. In this way, leaks of liquid water through the porous material of the open envelope can be avoided because the water is absorbed by the humidity control agent more rapidly than the time required for the water to leak.

According to another embodiment of the method, the at least one part of the open envelope for receiving the humidity control agent and the water is formed by a gas-impermeable body, and a given weight of water in a liquid state is introduced in the at least one part of the envelope formed by the gas-impermeable body before a given weight of the humidity control agent is also introduced therein. This may be implemented, e.g., for the manufacturing of humidity control capsules, canisters or stoppers, where the open envelope comprises a thermoplastic body. In this case, the liquid water may advantageously be introduced first in the thermoplastic body, and the humidity control agent may then be added thereto before closing the thermoplastic body with a gas-permeable cover. In this way, uncontrolled loss of water can be avoided, which may happen in case of injection of liquid water on a layer of humidity control agent already present in a small thermoplastic body. In addition, the potential volume expansion of the humidity control agent can be better controlled, especially in the case of a superabsorbent polymer, so as not to interfere with the placement of the gas permeable cover.

The method of the invention finds a particularly advantageous application in embodiments where the hydrated humidity control agent comprises a hydrated superabsorbent polymer. Indeed, it may be advantageous to introduce the superabsorbent polymer in the envelope in a state where its moisture content is relatively low because the viscosity or stickiness of the superabsorbent polymer may increase with increasing moisture content, possibly interfering with proper handling on a manufacturing line.

When the hydrated humidity control agent comprises a hydrated superabsorbent polymer, the sum of the weight of water and the weight of dry superabsorbent polymer is preferably higher than or equal to 90%, preferably higher than or equal to 93%, preferably higher than or equal to 97%, of the total weight of the hydrated humidity control agent, which means that the hydrated humidity control agent comprises a hydrated superabsorbent polymer as its main component. In this case, other components in the composition of the hydrated humidity control agent may include additives, added only in small amounts of less than 10 wt %, where the wt %-number provides the % of weight of the additives over the total weight of the hydrated humidity control agent. According to one embodiment, the hydrated superabsorbent polymer may be the sole component of the hydrated humidity control agent.

The inventors have found that the properties of superabsorbent polymers, in terms of water absorption and release, can be used to form a humidity control agent comprising a superabsorbent polymer and water as the main components. An amount of liquid water adjusted according to the targeted equilibrium relative humidity (ERHi) is added to a substantially dry superabsorbent polymer. Preferably, the resulting material is allowed to age and equilibrate for a period of at least 15 days at 20° C.±5° C., prior to being used as a humidity equilibrant. The weight of liquid water added is between 10% and 150% of the dry weight of the superabsorbent polymer, well below the total water retention capacity of the superabsorbent polymer.

The use of a hydrated superabsorbent polymer (or SAP) as a humidity control agent in a humidity control device for maintaining the relative humidity in an enclosure in the range of 45% RH to 90% RH has several advantages. First, a superabsorbent polymer exhibits a high rate of water absorption (or water retention) and remains in a solid or gel form even with a high moisture content. Thus, the envelope of a humidity control device according to the invention does not have to be liquid tight, which makes it possible to use the same envelope materials as those conventionally used for capsules or packets filled with desiccants.

Another advantage is that the moisture content of a hydrated superabsorbent polymer can be easily adjusted to reach different values of the targeted equilibrium relative humidity level (ERHi) within the broad relative humidity range of 45% RH to 90% RH. Thus, starting from one substantially dry superabsorbent polymer, it is possible to obtain humidity control devices with different values of the targeted equilibrium relative humidity level (ERHi), simply by modulating the hydration rate of the superabsorbent polymer, i.e. the quantity of water added thereto.

For example, a first type of pharmaceuticals or botanicals may be most stable and best consumed at a first humidity level of 60% RH, whereas a second type of pharmaceuticals or botanicals may be most stable and best consumed at a second humidity level of 70% RH. Thanks to the invention, the same superabsorbent polymer raw material and the same manufacturing line can be used to produce two types of humidity control devices intended for the two different types of products, i.e. a first type of humidity control devices for regulation at the first targeted equilibrium relative humidity level (ERH₁) of 60% RH, with a first moisture content (MC₁) of the superabsorbent polymer, and a second type of humidity control devices for regulation at a second targeted equilibrium relative humidity level (ERH₂) of 70% RH, with a second moisture content (MC₂) of the superabsorbent polymer.

According to one feature, the superabsorbent polymer has a water retention capacity greater than or equal to 30 times its weight in demineralized water, preferably greater than or equal to 50 times its weight in demineralized water, more preferably greater than or equal to 100 times its weight in demineralized water. In one embodiment, the superabsorbent polymer may be in a powder or granulate form, whether agglomerated or not. The structure of a superabsorbent polymer is typically based on a three-dimensional network similar to a multitude of small cavities each having the capacity to deform and absorb water, thus giving the superabsorbent polymer the capacity of absorbing very large quantities of water and the capacity of swelling.

According to one embodiment, the superabsorbent polymer comprises a natural polymer, e.g. it may be an alginate-based superabsorbent polymer.

According to one embodiment, the superabsorbent polymer is based on a cross-linked synthetic polymer or copolymer. In one embodiment, the monomers used for the preparation of the superabsorbent polymer, which are preferably partially or totally salified, may be chosen from: acrylamide and/or acrylic acid; and/or ATBS (acrylamide tertiary butyl sulfonic acid); and/or NVP (N-Vinylpyrrolidone); and/or acryloylmorpholine; and/or itaconic acid. According to one feature, the superabsorbent polymer is a cross-linked polymer comprising anionic charges carried by partially or totally salified acrylic acid monomers, such as a cross-linked sodium polyacrylate; a cross-linked potassium polyacrylate; a cross-linked copolymer acrylamide/potassium acrylate.

Examples of commercial superabsorbent polymers that may be used in the context of the invention include, without limitation: the products sold by the company Aprotek under the trademark APROPACK, based on sodium polyacrylate, in particular APROPACK G300; the products sold by the company Evonik Industries under the trademark FAVOR PAC, based on sodium polyacrylate, in particular FAVOR PAC 593 or FAVOR PAC 610. Advantageously, the superabsorbent polymer is suitable for food contact applications.

According to one feature, the hydrated superabsorbent polymer has an adjusted moisture content of between 10% and 150%, preferably between 10% and 120%, the moisture content of the hydrated superabsorbent polymer being the ratio of the weight of water to the weight of dry superabsorbent polymer.

According to one feature, an expansion factor of the humidity control agent arranged in the envelope, defined as the ratio of the volume of the humidity control agent to the volume of the dry superabsorbent polymer contained in the humidity control agent is less than 4, preferably less than 3, preferably less than 2. It is noted that, starting from a hydrated superabsorbent polymer, the volume of the corresponding dry superabsorbent polymer can be determined by placing the hydrated superabsorbent polymer in an oven at a temperature of 110° C.±5° C. for 24 hours and measuring the volume of the dried superabsorbent polymer thus obtained.

As explained above, adding liquid water to a superabsorbent polymer results in an increase in the volume of the superabsorbent polymer. The inventors have found that humidity equilibration properties in the range of 45% RH to 90% RH, preferably 50% RH to 80% RH, are achieved when the volume increase of the superabsorbent polymer is limited to a factor 4, preferably to a factor 3, preferably to a factor 2.

When the hydrated humidity control agent comprises a hydrated superabsorbent polymer, a ratio of the inner volume of the envelope to the volume of the dry superabsorbent polymer contained in the humidity control agent is less than 4, preferably less than 3, preferably less than 2. With such a volume of the envelope, the volume expansion of the superabsorbent polymer is limited by the envelope, and it is thus possible to limit the moisture content of the humidity control agent and the resulting equilibrium relative humidity (ERHi) to a maximum value. In other words, the targeted equilibrium relative humidity level (ERHi) may be obtained by selecting an appropriate inner volume of the envelope.

In one embodiment, the superabsorbent polymer is introduced in the at least one part of the open envelope in a substantially dry state. For example, the superabsorbent polymers APROPACK G300, FAVOR PAC 593 or FAVOR PAC 610, may be introduced in the envelope in their commercially available state, which is a substantially dry state of the superabsorbent polymer with a moisture content of less than or equal to 8%, corresponding to a powder or granulate form with good flowability.

In one embodiment of the method, the hydrated humidity control agent comprises a hydrated silica gel. When the hydrated humidity control agent comprises a hydrated silica gel, the sum of the weight of water and the weight of dry silica gel is preferably higher than or equal to 90%, preferably higher than or equal to 93%, preferably higher than or equal to 97%, of the total weight of the hydrated humidity control agent, which means that the hydrated humidity control agent comprises a hydrated silica gel as its main component. In this case, other components in the composition of the hydrated humidity control agent may include additives, added only in small amounts of less than 10 wt %, where the wt %-number provides the % of weight of the additives over the total weight of the hydrated humidity control agent. According to one embodiment, the hydrated silica gel may be the sole component of the hydrated humidity control agent.

In one embodiment of the method, the hydrated humidity control agent comprises a hydrated clay. When the hydrated humidity control agent comprises a hydrated clay, the sum of the weight of water and the weight of dry clay is preferably higher than or equal to 90%, preferably higher than or equal to 93%, preferably higher than or equal to 97%, of the total weight of the hydrated humidity control agent, which means that the hydrated humidity control agent comprises a hydrated clay as its main component. In this case, other components in the composition of the hydrated humidity control agent may include additives, added only in small amounts of less than 10 wt %, where the wt %-number provides the % of weight of the additives over the total weight of the hydrated humidity control agent. According to one embodiment, the hydrated clay may be the sole component of the hydrated humidity control agent.

In the above embodiments where the composition of the hydrated humidity control agent comprises a main component, which may be, e.g., a hydrated superabsorbent polymer, a hydrated silica gel or a hydrated clay, small amounts of additive materials may be added to the composition of the hydrated humidity control agent to provide additional properties thereto. Such additive materials may be, for example, humidity absorbers, oxygen scavengers, odor absorbers, emitters of volatile olfactory organic compounds, flavors, antibacterial materials, antifungal materials, etc. The weight proportion of the additive materials is limited to a maximum of 10% of the total weight of the hydrated humidity control agent. According to one feature, the equilibrium relative humidity level (ERHi) obtained from a humidity control device for which the composition of the hydrated humidity control agent comprises additive materials is within a range of ±7% RH, preferably ±5% RH, around the equilibrium relative humidity level obtained from a humidity control device for which the composition of the humidity control agent only comprises the same main component and the same amount of water.

According to one feature, in the closed configuration of the envelope, the hydrated humidity control agent is enclosed inside the envelope. In other words, the envelope enwraps the hydrated humidity control agent on all sides.

The targeted equilibrium relative humidity level (ERHi) according to the invention depends on a combination of the moisture content of the hydrated humidity control agent and the water vapor transfer capacity of the envelope. Conventionally, the water vapor transfer capacity of the envelope is defined as the amount of moisture transferred, into or out of the envelope, over a defined relative humidity range.

According to one feature, the envelope is liquid water resistant and water vapor permeable. Within the frame of the invention, a liquid water resistant envelope is an envelope which, in any orientation of the envelope, has a resistance to the passage of liquid water sufficient to allow for at least ⅔ of the inner volume of the envelope to be filled with liquid water without any liquid water leaking to the outer surface of the envelope during the filling time.

In practice, materials having a Frazier air permeance of less than 30 cm³·cm⁻²·s⁻¹ preferably less than 20 cm³·cm⁻²·s⁻¹, preferably less than 15 cm³·cm⁻²·s⁻¹, measured using the Frazier test method in accordance with standard test method ASTM D737, are appropriate to form a water resistant envelope as defined above.

According to one feature, the liquid water resistant envelope is either made entirely of a gas-permeable material having a Frazier air permeance of less than 30 cm³·cm⁻²·s⁻¹, preferably less than 20 cm³·cm⁻²·s⁻¹, preferably less than 15 cm³·cm⁻²·s⁻¹, or made of at least one part of a gas-impermeable material and at least one part of a gas-permeable material having a Frazier air permeance of less than 30 cm³·cm⁻²·s⁻¹, preferably less than 20 cm³·cm⁻²·s⁻¹, preferably less than 15 cm³·cm⁻²·s⁻¹. According to one feature, the material of the envelope is devoid of through holes having a size causing leakage of liquid water through the envelope.

In particular, the liquid water resistant envelope may comprise: macroporous materials, such as non-woven fabrics or perforated polymer films, for which the Frazier test method yields Frazier air permeance values higher than zero and less than 30 cm³·cm⁻²·s⁻¹; microporous materials, such as gas-permeable cardboards, for which Frazier air permeance values are substantially equal to zero; and/or homogenous gas-impermeable films; the thickness, exchange surface and water vapor transmission rate of the constitutive material(s) of the envelope being so selected as to achieve a water vapor transfer capacity of the envelope higher than or equal to 20 mg per 24 hours, preferably higher than or equal to 50 mg per 24 hours, in an environment at 30° C. with a relative humidity of 65% RH.

In practice, the water vapor transfer capacity of an envelope may be measured by any appropriate method known in the art, e.g. by filling the envelope with a desiccant material, such as a molecular sieve, and rapidly sealing the filled envelope in an environment with a low relative humidity of less than 50% RH. Of course, other desiccant materials may also be used in combination with or in place of molecular sieve, e.g. silica gel or anhydrous calcium chloride CaCl₂). The original weight of the filled envelope is measured. The filled envelope is then placed for 24 hours in a climatic chamber set at 30° ° C., 65% RH. After 24 hours, the weight of the filled envelope is measured again and the water vapor transfer capacity of the envelope per 24 hours is calculated from the difference between the two measurements of the weight of the filled envelope.

Advantageously, the method of the invention may be based on conventional envelope materials used for desiccant capsules, canisters or packets.

According to one embodiment, the envelope of the humidity control device comprises a gas-impermeable body of a capsule or a canister configured to receive the hydrated humidity control agent and at least one gas-permeable cover configured to close the body so that the hydrated humidity control agent is retained inside the envelope.

According to another embodiment, the envelope comprises walls of a closure intended to close an opening of a container, said walls defining a gas-impermeable body configured to receive the hydrated humidity control agent, and at least one gas-permeable cover configured to close the body so that the hydrated humidity control agent is retained inside the envelope.

According to another embodiment, the envelope comprises a gas-permeable membrane of a bag or a packet configured to enwrap the hydrated humidity control agent, such as a non-woven fabric or a perforated polymer film.

According to one feature of the method, the method further comprises a step in which the humidity control device is grouped with a plurality of other humidity control devices in a liquid and moisture-tight storage package, the number of humidity control devices grouped together in the storage package being preferably higher than 50, preferably higher than 100. Storing a plurality of humidity control devices inside the same moisture-tight storage package allows moisture to equilibrate between all the humidity control devices received in the storage package, so that variations in the moisture content from one humidity control device to another are smoothed. In this way, the tolerance interval for the moisture content and the targeted equilibrium relative humidity level (ERHi) of each humidity control device is reduced compared to that obtained when each humidity control device is packaged separately.

In one embodiment, the storage package may be a heat-sealable package comprising a multilayer material with at least one barrier layer providing gas barrier properties, e.g. an aluminum layer, and at least one heat-sealable layer, e.g. a polyethylene layer. Advantageously, the material of the storage package has a Water Vapor Transmission Rate (WVTR) of less than 0.1 g/m²-day (38° C., 90% RH) evaluated according to ASTM E398.

Another subject of the invention is a humidity control device obtained by the method as described above.

According to one feature of the humidity control device, the hydrated humidity control agent has an adjusted moisture content so selected as to provide a targeted equilibrium relative humidity level (ERHi) situated in the range of 10% RH to 100% RH, optionally 15% RH to 95% RH, optionally 25% RH to 90% RH, optionally 35% RH to 90% RH, optionally 45% RH to 90% RH, optionally 50% RH to 80% RH, in a sealed container.

According to one feature of the humidity control device, the time to reach the targeted equilibrium relative humidity level (ERHi) within ±2% RH, in an enclosure comprising the humidity control device, is less than 24 hours, preferably less than 6 hours, more preferably less than 2 hours. Such a kinetics of humidity control, which depends on the quantity of hydrated humidity control agent and the volume and permeability of the enclosure, ensures that the equilibrium relative humidity level is reached rapidly in an enclosure.

According to one embodiment of the humidity control device, the humidity control device is in the form of a humidity control capsule or canister, the liquid water resistant envelope comprising a gas-impermeable body configured to receive the hydrated humidity control agent and at least one gas-permeable cover configured to close the body so that the hydrated humidity control agent is retained inside the envelope. By way of non-limiting examples, a humidity control capsule may comprise a thermoplastic tubular body filled with the hydrated humidity control agent and closed by a gas-permeable cardboard for which the Frazier air permeance is substantially zero; a humidity control canister may comprise a thermoplastic tubular body filled with the hydrated humidity control agent and closed by a thermoplastic cap comprising at least one perforation covered by a gas permeable membrane having a Frazier air permeance of less than 30 cm³·cm⁻²·s⁻¹, preferably less than 20 cm³·cm⁻²·s⁻¹, preferably less than 15 cm³·cm⁻²·s⁻¹.

According to another embodiment of the humidity control device, the humidity control device is in the form of a humidity control closure intended to close an opening of a container, the liquid water resistant envelope comprising walls of the closure defining a gas-impermeable body configured to receive the hydrated humidity control agent and at least one gas-permeable cover configured to close the body so that the hydrated humidity control agent is retained inside the envelope. By way of a non-limiting example, a humidity control closure according to the invention may comprise a thermoplastic tubular body filled with the hydrated humidity control agent and closed by a gas-permeable cardboard for which the Frazier air permeance is substantially zero.

According to another embodiment of the humidity control device, the humidity control device is in the form of a humidity control bag or packet (or sachet), the liquid water resistant envelope comprising a gas permeable membrane configured to enwrap the hydrated humidity control agent, such as a non-woven fabric or a perforated polymer film having a Frazier air permeance of less than 30 cm³·cm⁻²·s⁻¹, preferably less than 20 cm³·cm⁻²·s⁻¹, preferably less than 15 cm³·cm⁻²·s⁻¹.

Examples of polymer fabrics that may be used for the envelope of a humidity control bag or packet according to the invention include non-woven fabrics based on polyethylene or polypropylene fibers. In particular, suitable materials include the products sold by the company DuPont under the trademark TYVEK, which are spun-bonded non-woven fabrics comprising polyethylene fibers, in particular based on high-density polyethylene (HDPE) fibers; the products sold by the company Unisel Co., Ltd under the trademark MELFIT, which are spun-bonded non-woven fabrics comprising polyethylene terephthalate (PET) fibers and polypropylene (PP) fibers. Examples of perforated polymer films that may be used for the envelope of a humidity control bag or packet according to the invention include perforated films of polyethylene or polypropylene.

### BRIEF DESCRIPTION OF THE DRAWINGS

Features and advantages of the invention will become apparent from the following description of embodiments of a manufacturing method and a humidity control device according to the invention, this description being given merely by way of example and with reference to the appended drawings in which:

FIG. 1 is a perspective view of a humidity control capsule according to a first embodiment of the invention, where the hydrated humidity control agent comprises a hydrated superabsorbent polymer;

FIG. 2 is a cross section according to plane II of FIG. 1;

FIG. 3 is a cross section of a closable bottle containing a plurality of nutraceutical gummies and the humidity control capsule of FIG. 1 for maintaining the relative humidity in the bottle within a given range around a targeted equilibrium relative humidity level;

FIG. 4 is a graph of the evolution of the relative humidity level over time of a humidity control capsule as shown in FIG. 1, with a moisture content of the hydrated superabsorbent polymer of the capsule corresponding to a first targeted equilibrium relative humidity level of the order of 60% RH, where the evolution of the relative humidity level over time has been measured by placing twenty humidity control capsules, each containing 1.5 g of hydrated superabsorbent polymer, in an empty and moisture-tightly closed glass vessel having a volume of 300 mL;

FIG. 5 is a graph similar to FIG. 4 of the evolution of the relative humidity level over time of a humidity control capsule as shown in FIG. 1, with a moisture content of the hydrated superabsorbent polymer of the capsule corresponding to a second targeted equilibrium relative humidity level of the order of 70% RH, where the evolution of the relative humidity level over time has been measured by placing twenty humidity control capsules, each containing 1.5 g of hydrated superabsorbent polymer, in an empty and moisture-tightly closed glass vessel having a volume of 300 mL;

FIG. 6 is a schematic top view of a manufacturing line for producing humidity control capsules similar to that of FIG. 1 and for packaging them into a liquid and moisture-tight storage package;

FIG. 7 is a perspective view of a humidity control bag according to a second embodiment of the invention, where the hydrated humidity control agent comprises a hydrated superabsorbent polymer;

FIG. 8 is a cross section according to plane VIII of FIG. 7;

FIG. 9 is a perspective view of a closable pouch containing a plurality of cannabis flowers and the humidity control bag of FIG. 7 for maintaining the relative humidity in the pouch within a given range around a targeted equilibrium relative humidity level;

FIG. 10 is a graph of the evolution of the relative humidity level over time of a humidity control bag as shown in FIG. 7, with a moisture content of the hydrated superabsorbent polymer of the bag corresponding to a targeted equilibrium relative humidity level of the order of 60% RH, where the evolution of the relative humidity level over time has been measured by placing one humidity control bag, containing 105 g of hydrated superabsorbent polymer, in an empty and moisture-tightly closed glass vessel having a volume of 1.5 L;

FIG. 11 is a schematic side view of a manufacturing line for producing humidity control bags similar to that of FIG. 7 and for packaging them into a liquid and moisture-tight storage package;

FIG. 12 is a perspective view of a humidity control canister according to a third embodiment of the invention, where the hydrated humidity control agent comprises a hydrated superabsorbent polymer;

FIG. 13 is a cross section according to plane XIII of FIG. 12;

FIG. 14 is a perspective view of a humidity control closure according to a fourth embodiment of the invention, where the hydrated humidity control agent comprises a hydrated silica gel;

FIG. 15 is a cross section according to plane XV of FIG. 14 of the closure sealingly closing a pharmaceutical container containing a plurality of hard gelatin capsules; and

FIG. 16 is a graph of the evolution of the relative humidity level over time of a humidity control closure as shown in FIG. 14, with a moisture content of the hydrated silica gel of the closure corresponding to a targeted equilibrium relative humidity level of the order of 30% RH, where the evolution of the relative humidity level over time has been measured by placing twenty humidity control closures, each containing 1.5 g of hydrated silica gel, in an empty and moisture-tightly closed glass vessel having a volume of 300 mL.

### ILLUSTRATIVE EMBODIMENTS OF THE INVENTION

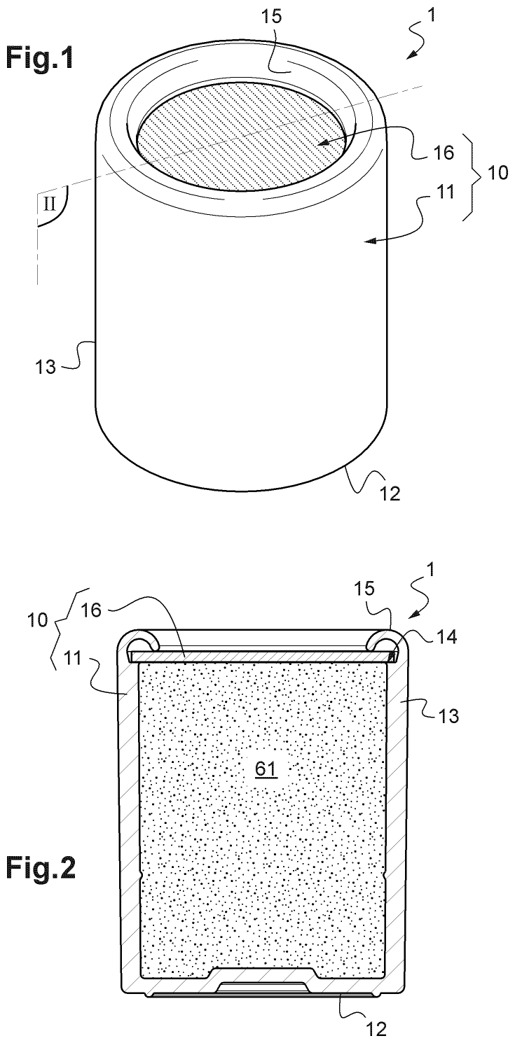

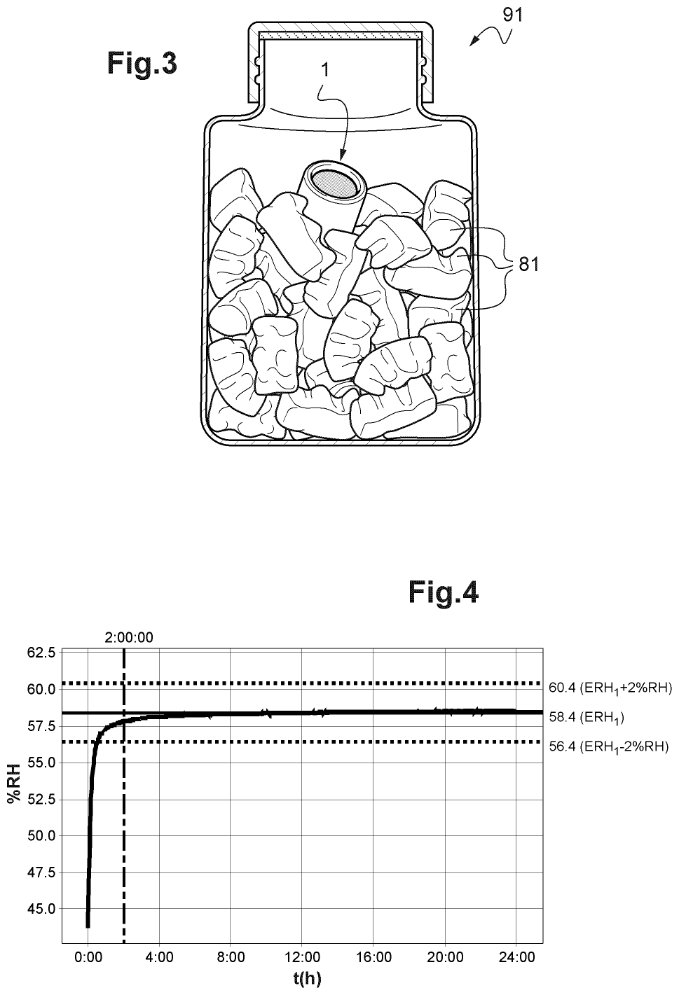

In the first embodiment shown in FIGS. 1 to 6, the humidity control device is a capsule 1 intended to be dropped in a packaging in which sensitive products are stored. By way of example, as illustrated in FIG. 3, the capsule 1 may be configured to control humidity inside a bottle 91 containing nutraceutical gummies 81 (also referred to as “gummy dosage forms”). Gummies are a useful oral administration form for patients who have difficulty swallowing pills or tablets, in particular elderly patients. Depending on the formulation, the texture and organoleptic properties of gummies may be best preserved in an environment with a relative humidity of between 45% RH and 70% RH. Typically, below 40% RH the gummies may become too hard, whereas above 70% RH they may undergo degradation of their active substance and/or become too sticky.

In this example, in order to ensure optimum storage and shelf life of the gummies 81, the humidity control capsule 1 is configured to maintain the relative humidity inside the bottle 91 within a range of ±10% RH around a given equilibrium relative humidity level ERHg selected in said range of between 45% RH and 70% RH. In this embodiment, the hydrated humidity control agent of the capsule 1 is a hydrated superabsorbent polymer 61, making it possible to remain within a range of ±10% RH thanks to its high buffering capacity.

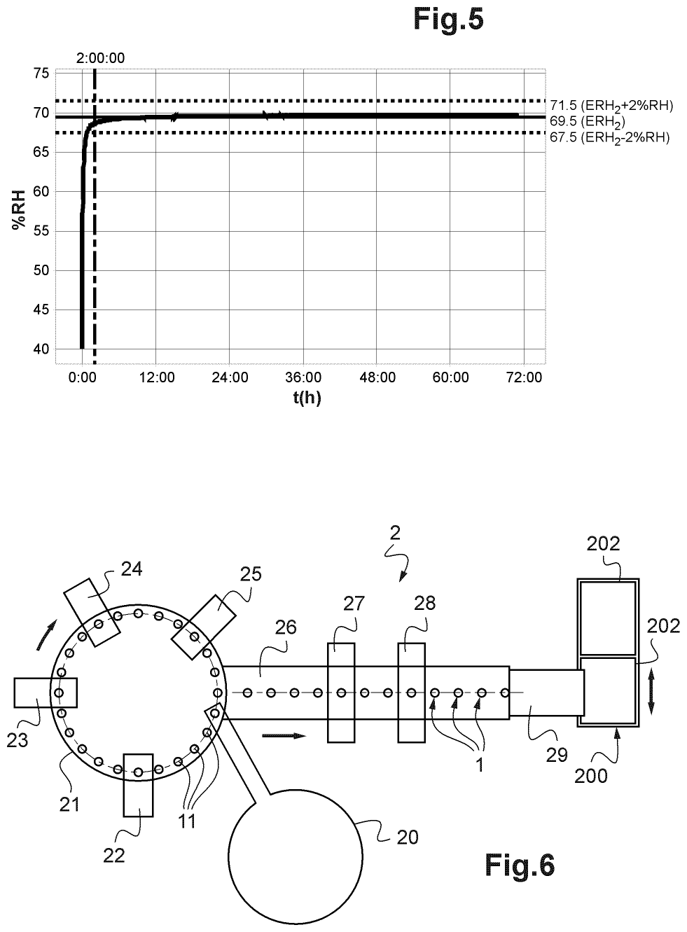

FIGS. 4 and 5 illustrate the regulation of the humidity obtained with two different types of capsules 1, comprising a first type of capsule 1 with a first targeted equilibrium relative humidity level ERH₁=58.4% RH, and a second type of capsule 1 with a second targeted equilibrium relative humidity level ERH₂=69.5% RH. The provision of humidity control capsules 1 with different targeted ERH values may be useful, for example, if a nutraceutical company has different formulations of gummies that are to be stored at different relative humidity levels.

The two types of capsules 1 of FIGS. 4 and 5 have the same structure, as shown in FIGS. 1 and 2, comprising an envelope 10 and the hydrated superabsorbent polymer 61 arranged inside the envelope 10. The envelope 10 comprises a tubular capsule body 11, with a bottom wall 12 and a side wall 13, delimiting a volume for receiving the hydrated superabsorbent polymer 61, and a gas-permeable cover 16, configured to close the capsule body 11 in such a way that the hydrated superabsorbent polymer 61 is retained inside the envelope. The two types of capsules 1 illustrated in FIG. 4 and FIG. 5 differ from each other only in the moisture content of the hydrated superabsorbent polymer 61 contained in the envelope 10, as will be detailed below.

By way of a non-limiting example, for each capsule 1 whose regulation profile is illustrated in FIG. 4 or FIG. 5, the capsule body 11 is an injection-molded part made of polypropylene; the gas-permeable cover 16 is a cardboard disc which is held in contact against a shoulder 14 of the capsule body by a thinner extension 15 of the side wall 13 which has been crimped; each capsule 1 contains 1.5 g of hydrated superabsorbent polymer 61 prepared by inserting in the capsule a given weight w_{w} of liquid water and a given weight wₚ of the product APROPACK G300 (sodium polyacrylate) sold by the company Aprotek, where the given weights w_{w} and wₚ of liquid water and APROPACK G300 are determined such that the obtained hydrated superabsorbent polymer has a moisture content corresponding to the targeted equilibrium relative humidity level ERH₁ or ERH₂.

More specifically, for the capsules 1 whose regulation profile is illustrated in FIG. 4, corresponding to the targeted equilibrium relative humidity level ERH₁=58.4% RH, the moisture content of the hydrated superabsorbent polymer 61 arranged inside the envelope 10 is 45.2%, which has been obtained by introducing in the capsule body a weight wₚ₁=0.974 g of the product APROPACK G300 having an initial moisture content of 7.75%, and a weight w_{w1}=0.365 g of liquid water. For the capsules 1 whose regulation profile is illustrated in FIG. 5, corresponding to the targeted equilibrium relative humidity level ERH₂=69.5% RH, the moisture content of the hydrated superabsorbent polymer 61 arranged inside the envelope 10 is 59.2%, which has been obtained by introducing in the capsule body a weight wₚ₂=0.981 g of the product APROPACK G300 having an initial moisture content of 7.75%, and a weight w_{w2}=0.504 g of liquid water.

Each capsule 1 thus obtained is capable of absorbing or releasing at least 100 mg of water vapor per gram of dry superabsorbent polymer, while still maintaining the relative humidity in an enclosure within a range of ±10% RH around the targeted equilibrium relative humidity level ERH₁ or ERH₂. This buffering capacity, which is a property conferred by the hydrated superabsorbent polymer 61 of the capsule, ensures that the relative humidity inside the bottle 91 is maintained within a range of ±10% RH around the equilibrium relative humidity level, even in the presence of instability factors, such as a certain permeability of the bottle to moisture, or the influence of the moisture content of the gummies 91 also present in the bottle.

More precisely, for the first type of capsule 1 having a hydrated superabsorbent polymer 61 with a moisture content of 45.2% corresponding to ERH₁=58.4% RH, measurements show that each capsule is capable of absorbing 140 mg of water vapor from the surrounding before ERH₁+10% RH is reached, and of releasing 135 mg of water vapor to the surrounding before ERH₁−10% RH is reached. For the second type of capsule 1 having a hydrated superabsorbent polymer 61 with a moisture content of 59.2% corresponding to ERH₂=69.5% RH, measurements show that each capsule is capable of absorbing 230 mg of water vapor from the surrounding before ERH₂+10% RH is reached, and of releasing 140 mg of water vapor to the surrounding before ERH₂−10% RH is reached.

In addition, as visible in FIGS. 4 and 5, for each of the two types of capsules 1 thus obtained, the time required to reach the targeted equilibrium relative humidity level ERH₁ or ERH₂, within ±2% RH, is less than 2 hours in the measurement conditions as mentioned above, i.e. where twenty humidity control capsules 1 are placed in an empty and moisture-tightly closed glass vessel having a volume of 300 mL, which corresponds to 100 g of hydrated superabsorbent polymer per liter of air in the closed glass vessel. More precisely, measurements show that, for the first type of capsule 1 having a hydrated superabsorbent polymer 61 with a moisture content of 45.2% corresponding to ERH₁=58.4% RH, the value ERH₁−2% RH=56.4% RH is reached in less than 32 minutes, whereas for the second type of capsule 1 having a hydrated superabsorbent polymer 61 with a moisture content of 59.2% corresponding to ERH₂=69.5% RH, the value ERH₂−2% RH=67.5% RH is reached in less than 50 minutes.

FIG. 6 illustrates schematically an example of a manufacturing line 2 for manufacturing humidity control capsules 1 as described above. As shown in FIG. 6, successive operations are performed in the manufacturing line 2 to assemble and package the capsules 1, i.e. successively: each capsule body 11 is filled and closed in consecutive stations 22-25; each capsule 1 is marked in a marking station 27; each capsule 1 is controlled in a control station 28, with regard to various quality attributes such as the marking quality, the crimping quality, the presence of any visual defect; each capsule 1 is conveyed through a rotating drum 29 toward a receptacle 200, in which a removable storage package 202 is placed which is suitable for the storage of the capsules before they are used as humidity control devices.

The storage package 202 is designed to receive a plurality of capsules 1, e.g. 1000 capsules, before being removed from the receptacle 200 and sealed. In the sealed configuration, the storage package 202 is liquid and moisture tight. In one embodiment, the storage package 202 is a heat-sealable pouch made from a multilayer material comprising at least one barrier layer providing gas barrier properties, e.g. an aluminum layer, and at least one heat-sealable layer, e.g. a polyethylene layer. The material of the storage package 202 advantageously has a Water Vapor Transmission Rate (WVTR) of less than 0.1 g/m²-day (38° C., 90% RH) evaluated according to ASTM E398. Storing a plurality of humidity control capsules 1 inside the same moisture-tight storage package 202 allows moisture to equilibrate between all the capsules 1 received in the storage package, so that variations in the moisture content from one capsule 1 to another are smoothed. In this way, the tolerance interval for the moisture content and the targeted equilibrium relative humidity level ERHi of each humidity control capsule 1 is reduced compared to that obtained when each capsule 1 is packaged individually.

As shown in FIG. 6, the manufacturing line 2 comprises a carousel 21 for receiving capsule bodies 11 from a vibrating bowl 20 and for moving the capsule bodies 11 through successive stations in which they are filled and closed. Each capsule body 11 is filled first with a given weight w_{w} of liquid water, in a water filling station 22, and then with a given weight wₚ of superabsorbent polymer, in a polymer filling station 23. As explained above, the given weights w_{w} and wₚ are determined such that the obtained hydrated superabsorbent polymer has a moisture content corresponding to a targeted equilibrium relative humidity level ERHi.

By way of example, for the manufacturing of the capsules 1 whose regulation profile is illustrated in FIG. 4, respectively FIG. 5, the value w_{w1}, respectively w_{w2}, is entered as an input parameter for the water filling station 22, whereas the value wₚ₁, respectively wₚ₂, is entered as an input parameter for the polymer filling station 23. In the polymer filling station 23, the product APROPACK G300 is provided in its commercially available state, which is a substantially dry state, e.g. with a moisture content of 7.75% as described above. Each dose of said given weight wₚ of superabsorbent polymer to be introduced in a capsule body 11 may advantageously be prepared using an automatic metering device.

In the illustrated embodiment, due to the small size of the capsule bodies 11, it is advantageous to introduce the water dose in the capsule body before the superabsorbent polymer dose, to avoid any uncontrolled loss of water. In case of injection of water on a layer of superabsorbent polymer already present in a small capsule body 11, there is a risk that the water will bounce back out of the capsule body, which does not allow perfect control of the moisture content of the resulting hydrated superabsorbent polymer. However, it is understood that, in variants of the invention, for example depending on the nature of the superabsorbent polymer and/or the shape and volume of the envelope parts receiving the water and the polymer doses, the steps of water filling and polymer filling may be reversed or implemented in any sequence order, or else there may be several alternating steps of water filling and polymer filling so as to create a sandwich structure which may be advantageous for a homogeneous distribution of water in the hydrated superabsorbent polymer.

Once it has been filled with the given weights of water and superabsorbent polymer, each capsule body 11 is moved by the carousel 21 to a closing station 24 in which a cardboard disc 16 is punched and applied on top of the filled capsule body 11, resting against the shoulder 14. The capsule body 11 is then moved by the carousel 21 to a crimping station 25, in which the thinner upper extension 15 of the capsule body is crimped, so that the cardboard disc 16 is held at its periphery and closes the capsule body 11 in such a way that the hydrated superabsorbent polymer is retained therein. The carousel 21 then places the filled and closed capsules 1 on a conveyor 26 which moves each capsule 1 successively through the marking station 27 and through the control station 28 in which quality attributes of each capsule 1 are controlled by means of a camera. The conveyor 26 then routes the capsules 1 though the rotating drum 29, from which they fall into the removable storage package 202 of the receptacle 200. Advantageously, the rotating drum ensures a certain degree of mixing of the capsules 1, which may be beneficial for the homogeneity of the hydrated superabsorbent polymer 61 in the capsules.

As can be seen from the above description, the method for manufacturing humidity control capsules 1 according to the invention is very similar to existing methods for manufacturing capsules filled with granular desiccants. Interestingly, the implementation of such a manufacturing method does not require massive changes in existing manufacturing lines, especially as the additional step of hydrating the active substance is easily integrated into the existing manufacturing lines.

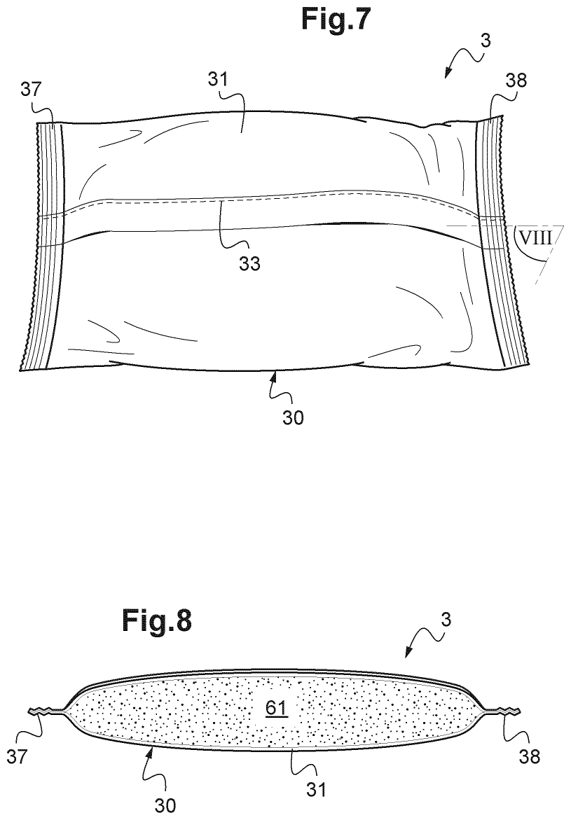

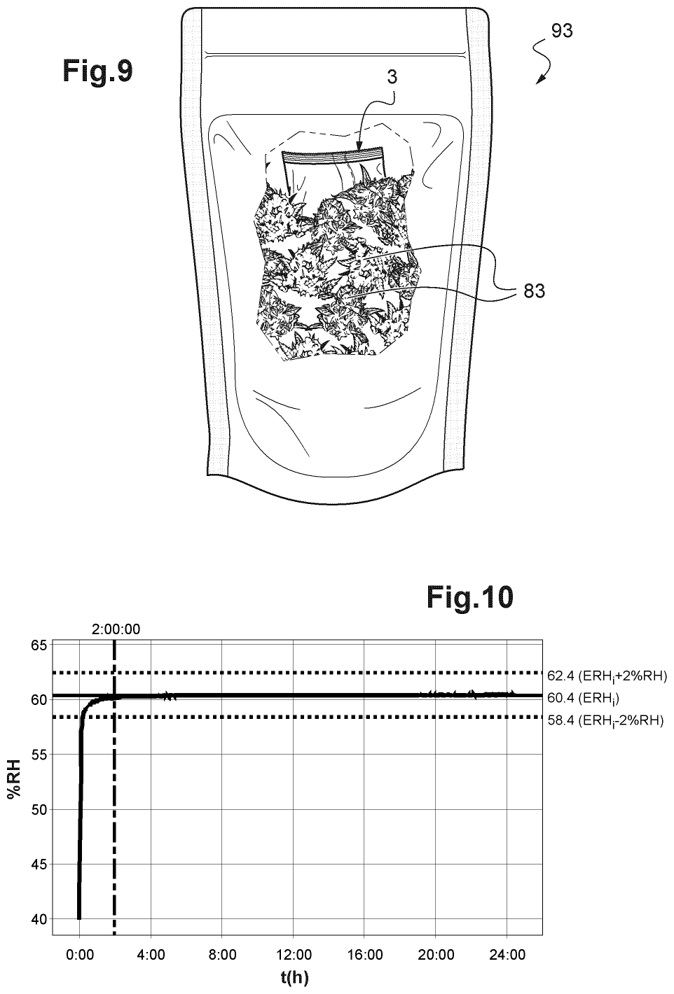

In the second embodiment shown in FIGS. 7 to 11, the humidity control device is a bag 3 intended to be dropped in a packaging in which sensitive products are stored. By way of example, as illustrated in FIG. 9, the bag 3 may be intended to control humidity inside a pouch 93 containing cannabis flowers or buds 83. The quality of cannabis flowers is best preserved in an environment with a relative humidity of between 50% RH and 65% RH. In this example, in order to ensure optimum storage and shelf life of the cannabis flowers 83, the humidity control bag 3 is configured to maintain the relative humidity inside the pouch 93 within a range of ±10% RH around a given equilibrium relative humidity level ERHg of the order of 60% RH.

As shown in FIGS. 7 and 8, the bag 3 comprises an envelope 30 and a hydrated humidity control agent 61 arranged inside the envelope 30. In accordance with the invention, the hydrated humidity control agent is a hydrated superabsorbent polymer 61 retained inside the envelope 30. The envelope 30 is formed by a gas permeable membrane 31, shaped in such a way as to delimit a volume for receiving the hydrated superabsorbent polymer 61. In the example represented in FIGS. 7 and 8, the envelope 30 comprises a longitudinal seal 33 and two side seals 37, 38. The hydrated superabsorbent polymer 61 contained in the envelope 30 of the bag 3 is prepared to have an adjusted moisture content corresponding to a targeted equilibrium relative humidity level ERHi of the bag 3. The hydrated superabsorbent polymer 61 makes it possible to remain within the range of ±10% RH around the targeted equilibrium relative humidity level ERHi thanks to its high buffering capacity.

FIG. 10 illustrates the regulation of the humidity obtained for a bag 3 configured to control the humidity at a targeted equilibrium relative humidity level ERHi=60.4% RH. By way of a non-limiting example, for the bag 3 whose regulation profile is illustrated in FIG. 10, the gas permeable membrane 31 of the envelope is a spun-bonded non-woven fabric BT060UW comprising polyethylene terephthalate (PET) fibers and polypropylene (PP) fibers, sold by the company Unisel Co., Ltd, which has been welded at a longitudinal seal 33 and two side seals 37, 38, as shown in FIGS. 7 and 8; the bag 3 contains 105 g of a hydrated superabsorbent polymer 61 which has been prepared in situ in the envelope 30, by adding a given weight w_{w} of liquid water to a given weight wₚ of the product APROPACK G300 (sodium polyacrylate) sold by the company Aprotek, having an initial moisture content of 7.75%, in such a way as to reach a moisture content of the hydrated superabsorbent polymer 61 of 46.8% corresponding to said ERHi=60.4% RH. In this example, for each bag 3, the 105 g of hydrated superabsorbent polymer 61 are prepared by mixing a weight w_{w}=29.7 g of liquid water with a weight wₚ=75.3 g of the product APROPACK G300 having an initial moisture content of 7.75%.

The bag 3 thus obtained is capable of absorbing or releasing at least 100 mg of water vapor per gram of dry superabsorbent polymer, while still maintaining the relative humidity in the pouch 93 within a range of ±10% RH around the equilibrium relative humidity level. In addition, as visible in FIG. 10, the time required to reach the targeted equilibrium relative humidity level ERHi=60.4% RH, within ±2% RH, is less than 2 hours in the measurement conditions as mentioned above, i.e. where one bag 3 is placed in an empty and moisture-tightly closed glass vessel having a volume of 1.5 L, which corresponds to 105 g of hydrated superabsorbent polymer per liter of air in the closed glass vessel. More precisely, the value ERHi-2% RH=58.4% RH is reached in less than 14 minutes.

It is noted that the spun-bonded non-woven fabric BT060UW of the envelope 30 has a Frazier air permeability of 15±6 cm³·cm⁻²·s⁻¹, measured using the Frazier test method in accordance with standard test method ASTM D737. A test was carried out, in which an envelope with outer dimensions of 70 mm×100 mm was formed from this non-woven fabric BT060UW, having a total inner volume of about 80 cm³. This envelope was filled at a rate of 2.5 mL/s with about 50 mL (i.e. about ⅔ of total inner volume of the envelope) of liquid water without any liquid water leaking to the outer surface of the envelope.

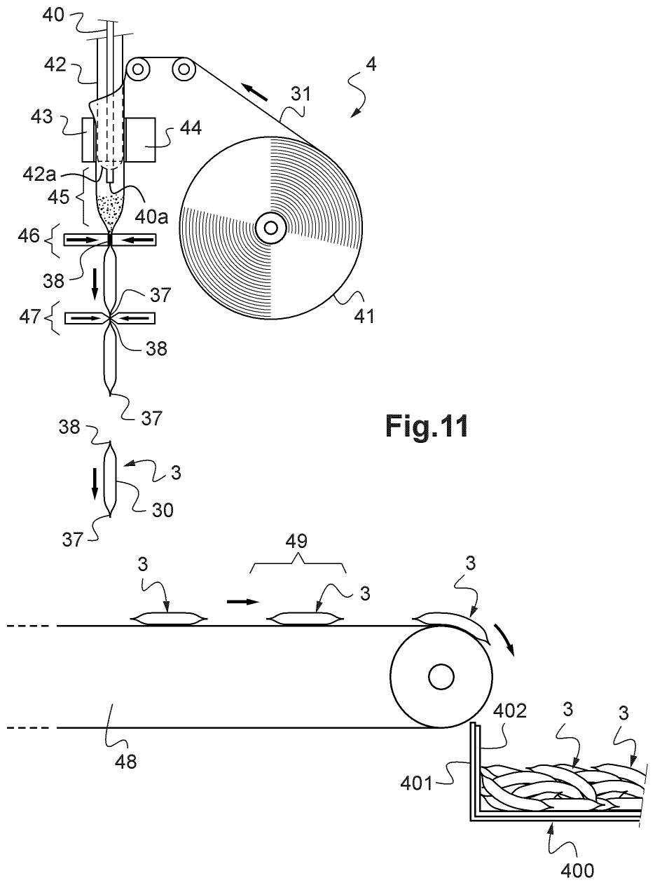

FIG. 11 illustrates schematically an example of a continuous manufacturing line 4 for manufacturing humidity control bags 3 as described above. In this second embodiment, the hydrated superabsorbent polymer 61 is prepared in situ in the envelope in a filling station 45. More precisely, the weight wₚ=75.3 g of the product APROPACK G300 is first inserted in the envelope 30 of each bag 3 in the filling station 45, and then the weight w_{w}=29.7 g of liquid water is injected in the envelope 30. The superabsorbent polymer in its commercially available state, which is a substantially dry state with a moisture content of 7.75%, exhibits a good flowability.

As shown in FIG. 11, successive operations are performed in the manufacturing line 4 to assemble and package the humidity control bags 3. First, the envelope 30 of the successive bags 3 is shaped, partially sealed and brought into the filling station 45 in an open configuration. For this purpose, an elongated web of non-woven material 31 is supplied from a reel 41 and wrapped around a mandrel 42 into a tubular shape comprising a longitudinal overlapping sealing area. A longitudinal seal 33 is then formed in the overlapping area, by welding the web of non-woven material 31, e.g. by ultrasonic welding, in a longitudinal welding station 43.

At the same time as the longitudinal seal 33 is formed in the longitudinal welding station 43, the envelope 30 of each bag 3 is marked in a marking station 44 positioned opposite the longitudinal welding station 43. Then, the tube of non-woven material 31 is advanced toward a transverse welding station 46, positioned downstream of the longitudinal welding station 43, in which a transverse seal is formed by welding the web of non-woven material 31 transversally to the longitudinal seal 33, e.g. by ultrasonic welding. The transverse seal formed in the transverse welding station 46 is designed to simultaneously form a first side seal 37 of an upstream bag 3 to be filled with the hydrated superabsorbent polymer 61 in the filling station 45, and a second side seal 38 of a downstream bag 3 which has already been filled with the hydrated superabsorbent polymer 61 in the filling station 45.

When the transverse seal has been formed in the transverse welding station 46, the weight wₚ=75.3 g of the product APROPACK G300, in its commercially available state, is first inserted in the envelope 30 of each bag 3 which is received in the filling station 45, and then the weight w_{w}=29.7 g of liquid water is injected in the envelope 30. To be brought into the envelope, the superabsorbent polymer flows in the inner volume of the mandrel 42, whereas the liquid water flows in a water inlet duct 40 positioned centrally inside the mandrel. By first introducing the superabsorbent polymer in a substantially dry state in the open envelope, and then injecting the liquid water in the open envelope, leaks of liquid water through the porous material of the open envelope 30 can be avoided because the water is absorbed by the superabsorbent polymer almost instantaneously, and in any case more rapidly than the time required for the water to leak.

Of course, other relative arrangements of the duct 40 and the mandrel 42 are possible, e.g., the duct 40 may be positioned on one side of the mandrel 42, instead of centrally inside the mandrel. However, the arrangement shown in FIG. 11 is advantageous in that a central position of the duct 40 inside the mandrel 42 ensures a homogeneous distribution of water in the hydrated superabsorbent polymer 61. The arrangement shown in FIG. 11 is also advantageous in that the free end 40a of the duct 40 protrudes more towards the envelope 30 than the free end 42a of the mandrel 42. This, combined with the injection of the superabsorbent polymer and the water one after the other, prevents a risk that the water will bounce back out of the envelope 30 and be deposited on the inner walls of the mandrel 42, which could generate the formation of a plug of expanded superabsorbent polymer at the end of the mandrel 42.

Once the desired weight of hydrated superabsorbent polymer 61 has been formed in the envelope 30, the bag 3 which is received in the filling station 45 is advanced until its downstream end reaches a cutting station 47, positioned downstream of the transverse welding station 46, and in this position its open upstream end is received in the transverse welding station 46. Then, a new transverse seal is formed in the transverse welding station 46, thus forming a second side seal 38 of the bag 3 to close the upstream end of the bag 3. As explained previously, the transverse seal formed in the transverse welding station 46 also forms a first side seal 37 of an upstream bag 3 to be filled in the filling station 45. While the upstream end of the bag 3 is closed in the transverse welding station 46, the junction between the bag 3 and a downstream bag 3 is also cut in the cutting station 47, thus separating the first side seal 37 of the bag 3 from the second side seal 38 of the downstream bag 3. In the next step, the second side seal 38 of the bag 3 reaches the cutting station 47, where the junction between the bag 3 and an upstream bag 3 is cut. The bag 3 filled with the hydrated superabsorbent polymer 61 is thus detached from the rest of the web of non-woven material 31 and falls on a conveyor 48 configured to move the bags 3 through the last stations of the manufacturing line 4.

The bags 3 received on the conveyor travel in a control station 49, in which each bag 3 is visually inspected by an operator for various quality attributes, such as the marking quality, welding quality, and more generally the presence of any visual defect. Each bag 3 is then displaced by the conveyor 48 toward a receptacle 400, e.g. a cardboard, in which a storage package 402 is placed, e.g. a heat-sealable pouch made from a multilayer material comprising at least one barrier layer providing gas barrier properties, such as an aluminum layer, and at least one heat-sealable layer, such as a polyethylene layer. The storage package 402 is designed to receive a plurality of bags 3, e.g. 80 bags, before being sealed. In the sealed configuration, the storage package 402 is liquid and moisture tight. In a manner similar to the first embodiment, the material of the storage package 402 advantageously has a Water Vapor Transmission Rate (WVTR) of less than 0.1 g/m²-day (38° C., 90% RH) evaluated according to ASTM E398. Here again, storing a plurality of humidity control bags 3 inside the same moisture-tight storage package 402 allows moisture to equilibrate between all the bags 3 received in the storage package, so that variations in the moisture content from one bag 3 to another are smoothed. In this way, the tolerance interval for the moisture content and the targeted equilibrium relative humidity level ERHi of each humidity control bag 3 is reduced.

Here again, the method for manufacturing humidity control bags 3 according to the invention is very similar to existing methods for manufacturing bags filled with granular desiccants, and its implementation does not require massive changes in existing manufacturing lines. The only adaptation to be considered in the above example is the provision of the water inlet duct 40 in the filling station 45.

Of course, the water filling station may come in other forms. In particular, in the above example, the water filling station and the polymer filling station are both located at the location of the filling station 45 in FIG. 11, in which case the water and the substantially dry superabsorbent polymer are both inserted into the envelope 30 of each bag while it is still open. As a variant, the water filling station may be provided downstream of the polymer filling station and the transverse welding station 46, in which case the water is inserted into the envelope 30 of each bag after the envelope has been filled with the substantially dry superabsorbent polymer and sealed. For example, the water filling station may comprise means for injecting liquid water into the filled and sealed envelope 30 of each bag with a syringe through a hole in the envelope and welding the hole once the desired weight of liquid water has been injected into the envelope, so as to close the envelope. The size of the hole and the kinetics of water absorption by the humidity control agent may also be dimensioned so that it is not necessary to weld the hole once the desired weight of liquid water has been injected into the envelope, while still ensuring that the hydrated humidity control agent is retained within the envelope.

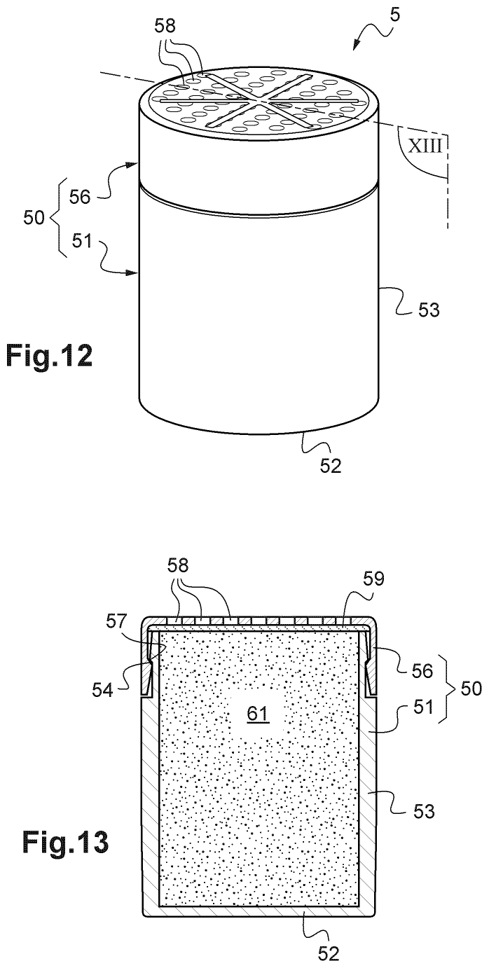

In the third embodiment shown in FIGS. 12 and 13, the humidity control device is a canister 5. In the same way as the capsule 1 of the first embodiment or the bag 3 of the second embodiment, the canister 5 is intended to be dropped in a container (not represented) in which sensitive products are stored, such as a bottle, a pouch or any other type of container. The canister 5 is configured to maintain the relative humidity inside the container within a given range around a given equilibrium relative humidity level adapted for the storage of the sensitive products. To this end, the envelope 50 of the canister 5 contains a hydrated superabsorbent polymer 61 having an adjusted moisture content corresponding to a targeted equilibrium relative humidity level.

As shown in FIGS. 12 and 13, the envelope 50 of the canister 5 comprises a tubular body 51 and a gas-permeable cap 56, which may advantageously be obtained by injection molding of a thermoplastic material such as polyethylene. The gas-permeable cap 56 is provided with a plurality of perforations 58 and is configured to be fastened on the tubular body 51, e.g. by clipping using complementary clipping members 54 and 57 of the body and the cap, as shown in FIG. 13. The tubular body 51 comprises a bottom wall 52 and a side wall 53 delimiting a volume for receiving the hydrated superabsorbent polymer 61, which is closed by the gas-permeable cap 56.

Depending on the granulometry (or particle size) of the hydrated superabsorbent polymer 61, a porous membrane may also be used to cover the perforations 58 of the cap 56, in order to avoid escape of particles of hydrated superabsorbent polymer 61 through the perforations 58 that may contaminate the products contained in the packaging. Such escape of particles may happen when the size of the particles is less than that of the perforations 58. In this case, as shown in the example of FIG. 13, a porous disc 59 may advantageously be placed against the internal face of the cap 56, e.g. a disc of non-woven fabric comprising polyethylene fibers such as TYVEK manufactured by DuPont, or a disc of gas-permeable cardboard. In particular, the porous disc 59 may be assembled with the cap 56 by inserting the disc 59 in the cap 56 or by over-molding the cap 56 around the disc 59.

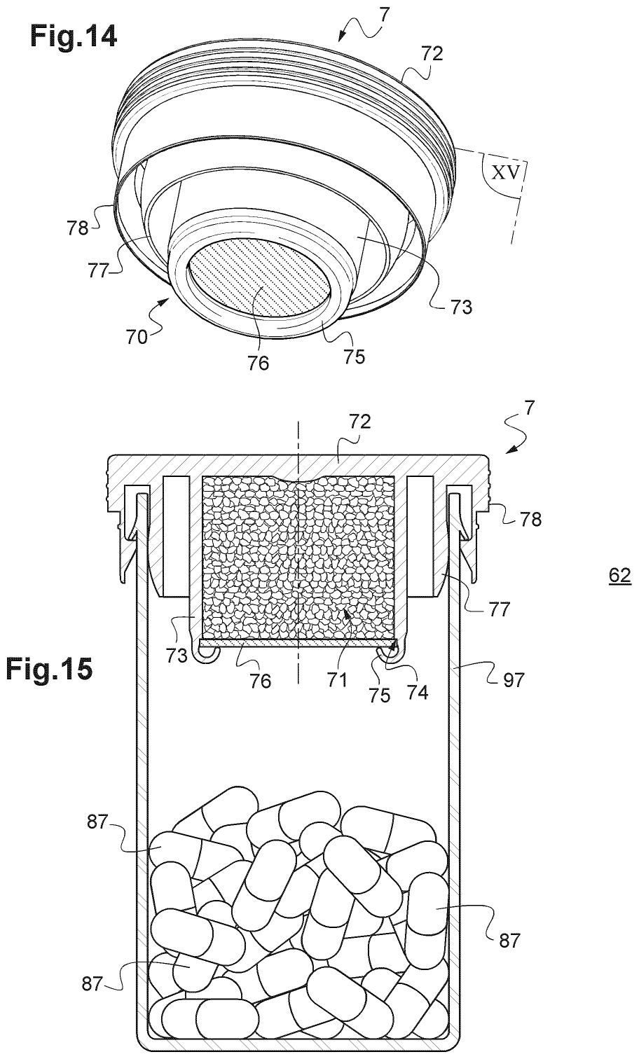

In the fourth embodiment shown in FIGS. 14 and 15, the humidity control device is a closure 7 intended to close an opening of a container 97 in which sensitive products are stored. By way of example, as illustrated in FIG. 15, the closure 7 may be configured to control humidity inside the pharmaceutical container 97 containing hard gelatin capsules 87. The closure 7 is configured to exchange water vapor with the inner volume of the container 97 so as to maintain the relative humidity inside the container 97 within a given range around a given equilibrium relative humidity level adapted for the storage of the gelatin capsules 87. In this example, the humidity control closure 7 is configured to maintain the relative humidity inside the container 97 within a range of ±10% RH around a given equilibrium relative humidity level ERHg of the order of 30% RH. To this end, the closure 7 defines an envelope 70 for receiving a hydrated silica gel 62 having an adjusted moisture content corresponding to the targeted equilibrium relative humidity level.

More precisely, the envelope 70 comprises a top wall 72 of the closure and an annular wall 73 projecting from the top wall 72, thus defining a hollow body 71 for receiving the hydrated silica gel 62. The hollow body 71 is closed by a gas-permeable cover 76, which retains the hydrated silica gel 62 inside the hollow body. In the represented example, the gas-permeable cover 76 is a cardboard held in contact against a shoulder 74 at its periphery by thinner extensions 75 of the annular wall 73 which have been crimped. As shown in FIG. 15, when the closure 7 is closed onto the container 97, the annular wall 73 extends towards the inside of the container 97 so that water vapor can be exchanged between the inner volume of the container 97 and the hydrated silica gel 62.

The closure 7 also comprises a sealing skirt 77 which extends from the top wall 72 and is configured to establish a sealing contact with an inner wall surface of the container 97 surrounding its opening. Radially outside the sealing skirt 77 and concentrically arranged relative to the sealing skirt 77 is an outer rim 78. The rim 78 can for example cooperate with the sealing skirt 77 to establish a moisture-tight seal with the wall of the container 97 surrounding its opening. The rim 78 can also be connected to a tamper evident ring for providing a visual indication of first opening to an end user. The rim 78 can also comprise a surface, a cavity or any geometry facilitating the opening of the container 97 by the end user.

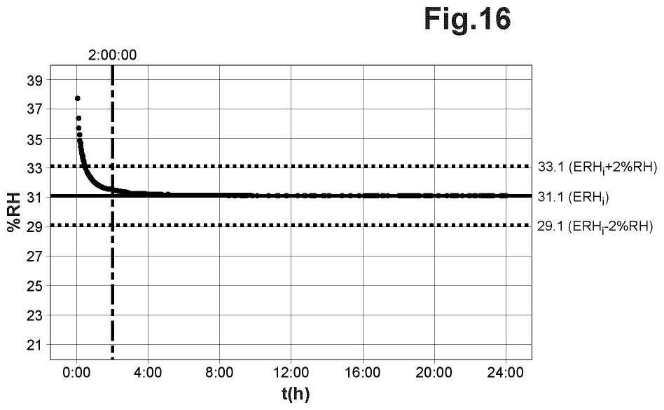

FIG. 16 illustrates the regulation of the humidity obtained for a closure 7 configured to control the humidity at a targeted equilibrium relative humidity level ERHi=31.1% RH. By way of a non-limiting example, for the closure 7 whose regulation profile is illustrated in FIG. 16, the hollow body 71 is injection-molded from polypropylene; the gas-permeable cover 76 is a cardboard disc which is held in contact against a shoulder 74 of the hollow body 71 by a thinner extension 75 of the side wall 73 which has been crimped; the closure 7 contains 1.5 g of hydrated silica gel 62 prepared by inserting in the closure a given weight w_{w} of liquid water and a given weight wₚ of Silica Gel 11132 available from Chemsource, where the given weights w_{w} and wₚ are determined such that the obtained hydrated silica gel 62 has a moisture content corresponding to the targeted equilibrium relative humidity level ERHi.

As visible in FIG. 16, the time required to reach the targeted equilibrium relative humidity level ERHi=31.1% RH, within ±2% RH, is less than 2 hours in the measurement conditions as mentioned above, i.e. where twenty humidity control closures, each containing 1.5 g of hydrated silica gel, are placed in an empty and moisture-tightly closed glass vessel having a volume of 300 mL. More precisely, the value ERHi+2% RH=33.1% RH is reached in less than 50 minutes.

Humidity control closures 7 as described above can be manufactured using a manufacturing line similar to that of FIG. 6, in which successive operations are performed to assemble and package the closures 7, i.e. successively: each hollow body 71 is filled first with the given weight w_{w} of liquid water, in the water filling station 22; then, each hollow body 71 is filled with the given weight wₚ of silica gel, in the filling station 23; then, each hollow body 71 is closed in the stations 24-25, in which a cardboard disc 76 is punched and applied on top of the filled body 71, resting against the shoulder 74, and crimped; each closure 7 is marked in the marking station 27; each closure 7 is controlled in the control station 28 and then conveyed through the rotating drum 29 toward the receptacle 200, in which a removable storage package 202 is placed which is suitable for the storage of the closures 7 before they are used as humidity control devices.

The invention is not limited to the examples described and shown.

In particular, other equilibrium relative humidity levels than those illustrated above for gummies, cannabis flowers and gelatin capsules can also be targeted with a humidity control device manufactured according to the method of the invention, comprised in the broad range of 10% RH to 100% RH.

In addition, the method of the invention, in which a hydrated humidity control agent is prepared in situ in the envelope of the humidity control device, may be implemented for any type of hydrated humidity control agent, e.g. a hydrated superabsorbent polymer, a hydrated silica gel, a hydrated molecular sieve, a hydrated clay, or any combination thereof. For the preparation of the hydrated humidity control agent in situ in the envelope of the device, the introduction of the humidity control agent and liquid water in the envelope can be carried out in any number of steps and in any sequence order.

In the case of a bag or a packet, as mentioned previously, the water may be inserted into the envelope either before or after the envelope is sealed. In particular, liquid water may be added to a sealed envelope filled with a humidity control agent in many possible ways, e.g., without limitation, by injecting liquid water into the filled and sealed envelope with a syringe through a hole forming an opening in the envelope, and welding the hole once the desired weight of liquid water has been injected into the envelope so as to close the envelope. The size of the hole and the kinetics of water absorption of the humidity control agent may also be dimensioned so that it is not necessary to weld the hole once the desired weight of liquid water has been injected into the envelope, while still ensuring that the hydrated humidity control agent is retained within the envelope.

Of course, many other variants can be considered, falling within the scope of the appended claims.

1. A method of manufacturing a humidity control device for maintaining relative humidity in an enclosure within a given range by absorbing or releasing water vapor, said humidity control device comprising a water vapor permeable envelope and a hydrated humidity control agent arranged inside the envelope, wherein the hydrated humidity control agent has an adjusted moisture content selected to provide a targeted equilibrium relative humidity level (ERHi) in a sealed container, said method comprising the steps of:
a) providing the envelope in an open configuration;
b) introducing, in at least one part of the open envelope, a given weight of the humidity control agent having a known moisture content lower than the moisture content corresponding to the targeted equilibrium relative humidity level (ERHi);
c) introducing a given weight of water in the at least one part of the open envelope.

2. The method according to claim 1, further comprising closing the envelope when a desired weight of hydrated humidity control agent, having the moisture content corresponding to the targeted equilibrium relative humidity level (ERHi) is received in the at least one part of the open envelope, so that the hydrated humidity control agent is retained inside the envelope.

3. The method according to claim 1, wherein the hydrated humidity control agent of the humidity control device is in a powder form, a granulate form or a solid agglomerated form.

4. The method according to claim 1, wherein the humidity control agent is introduced in the at least one part of the open envelope in a substantially dry state.

5. The method according to claim 1, wherein the water is introduced in the at least one part of the open envelope in a liquid state.

6. The method according to claim 1, wherein the given weights of water and of humidity control agent are introduced in the at least one part of the open envelope at a rate such that the time required for the water to be absorbed by the humidity control agent is lower than the time required for the water to leak out of the at least one part of the open envelope.

7. The method according to claim 1, wherein the at least one part of the open envelope for receiving the humidity control agent and the water is formed by a gas-permeable membrane, and a given weight of the humidity control agent is introduced in the at least one part of the open envelope formed by the gas-permeable membrane before a given weight of water in a liquid state is also introduced therein.

8. The method according to claim 1, wherein the at least one part of the open envelope for receiving the humidity control agent and the water is formed by a gas-impermeable body, and a given weight of water in a liquid state is introduced in the at least one part of the envelope formed by the gas-impermeable body before a given weight of the humidity control agent is also introduced therein.

9. The method according to claim 1, wherein the hydrated humidity control agent of the humidity control device comprises a hydrated superabsorbent polymer.

10. The method according to claim 9, wherein a ratio of an inner volume of the envelope to a volume of the dry superabsorbent polymer contained in the humidity control agent is less than 4.

11. The method according to claim 1, wherein the hydrated humidity control agent of the humidity control device comprises a hydrated silica gel.

12. The method according to claim 1, wherein the hydrated humidity control agent of the humidity control device comprises a hydrated clay.

13. The method according to claim 1, wherein the envelope has a water vapor transfer capacity higher than 20 mg per 24 hours, in an environment at 30° C. with a relative humidity of 65% RH.

14. The method according to claim 1, further comprising a step in which the humidity control device is grouped with a plurality of other humidity control devices in a liquid and moisture-tight storage package, wherein the number of humidity control devices grouped together in the storage package is higher than 50.

15. The method according to claim 1, wherein the humidity control device is a humidity control capsule or canister, wherein the envelope comprises a gas-impermeable body configured to receive the hydrated humidity control agent and at least one gas-permeable cover configured to close the body so that the hydrated humidity control agent is retained inside the envelope.

16. The method according to claim 1, wherein the humidity control device is a humidity control closure intended to close an opening of a container, wherein the envelope comprises walls of the closure defining a gas-impermeable body configured to receive the hydrated humidity control agent and at least one gas-permeable cover configured to close the body so that the hydrated humidity control agent is retained inside the envelope.

17. The method according to claim 1, wherein the humidity control device is a humidity control packet or bag, wherein the envelope comprises a gas-permeable membrane configured to enwrap the hydrated humidity control agent.

18. A humidity control device obtained by the method of claim 1.

19. The humidity control device according to claim 18, wherein the hydrated humidity control agent has an adjusted moisture content selected to provide a targeted equilibrium relative humidity level (ERHi) situated in the range of 10% RH to 100% RH in a sealed container.

20. The humidity control device according to claim 18, wherein the time to reach the targeted equilibrium relative humidity level (ERHi) within ±2% RH in an enclosure comprising said humidity control device, is less than 24 hours.

21. The method according to claim 1, further comprising repeating steps b) and c) until a desired weight of hydrated humidity control agent, having the moisture content corresponding to the targeted equilibrium relative humidity level (ERHi) of the humidity control device, is received in the at least one part of the open envelope.
